(19) United States
(12) Patent Application Publication
(10) Pub. No.: US 2014/0014673 A1
(43) Pub. Date: Jan. 16, 2014

(54) VENDING MACHINE AND METHOD OF OUTPUTTING MERCHANDISES OF VENDING MACHINE

(71) Applicants: YUN-LUNG CHEN, Tu-Cheng (TW); CHIN-WEN YEH, Tu-Cheng (TW); YANG XIAO, Wuhan City (CN); CHAO FENG, Wuhan City (CN)

(72) Inventors: YUN-LUNG CHEN, Tu-Cheng (TW); CHIN-WEN YEH, Tu-Cheng (TW); YANG XIAO, Wuhan City (CN); CHAO FENG, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/569,281

(22) Filed: Aug. 8, 2012

(30) Foreign Application Priority Data
Jul. 13, 2012 (CN) 2012102426300

(51) Int. Cl. G07F 11/72; B65G 59/00

(52) U.S. Cl. 221/1; 221/7

(57) ABSTRACT

A vending machine includes a front plate with an opening, a delivery tray, and a shielding plate rotatably attached to the cabinet. The delivery tray is attached to the front plate and defines an entrance. A first electromagnet, a second electromagnet, and one or more sensors are located on the delivery tray. The sensor(s) is connected to the first electromagnet and the second electromagnet. The sensor(s) detects merchandise dropping into the delivery tray and sends a signal to the first electromagnet and the second electromagnet; when the sensor detects no merchandise in the delivery tray, the shielding is engaged with the first electromagnet to cover the opening; when the sensor detects the merchandise in the delivery tray, the shielding is engaged with the second electromagnet to cover the entrance. A merchandise output method of the vending machine is also provided.

### BACKGROUND

1. Technical Field

The present disclosure relates to electronic devices, more particularly to a vending machine and merchandises outputting method of the vending machine.

2. Description of Related Art

Vending machines allow customers to buy a lot of merchandises twenty fours a day, such as buying water, papers and so on. When the customer retrieves the merchandises from the vending machine, a shielding plate is pushed by the customer to obtain the merchandises from a cabinet of the vending machine. However, a gap is left between the shielding plate and the cabinet. It is possible to obtain merchandises directly through the gap without paying. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine in accordance with an embodiment.

FIG. 2 is an exploded, isometric view of a cabinet and a shielding plate of the vending machine in accordance with an embodiment.

FIG. 3 is an assembled view of FIG. 2, and the shielding plate of the vending machine is located in a lower position.

FIG. 4 is an assembled view of FIG. 1, and the shielding plate of the vending machine is located in a lower position.

FIG. 5 is similar to FIG. 3, but the shielding plate of the vending machine is located in a higher position.

FIG. 6 is similar to FIG. 4, but the shielding plate of the vending machine is located in a higher position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

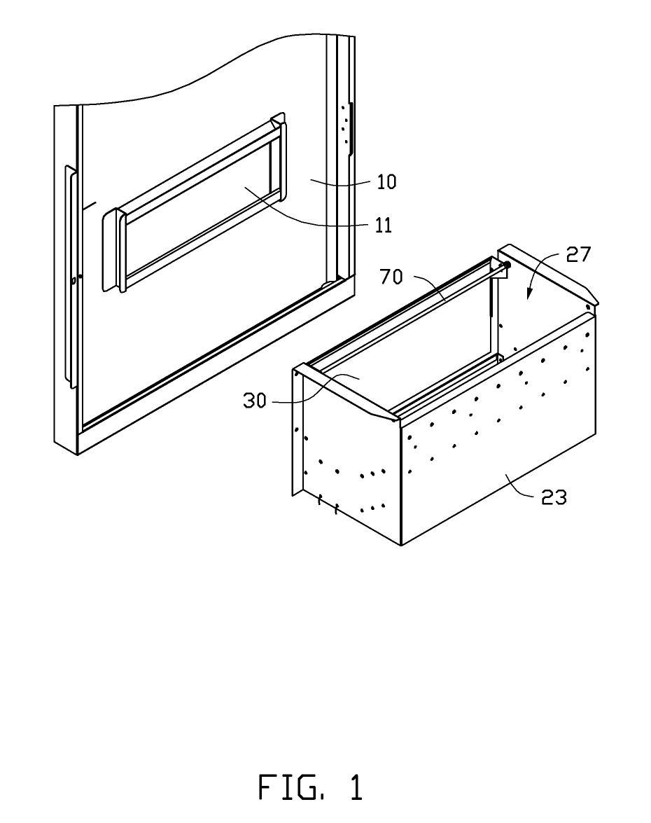

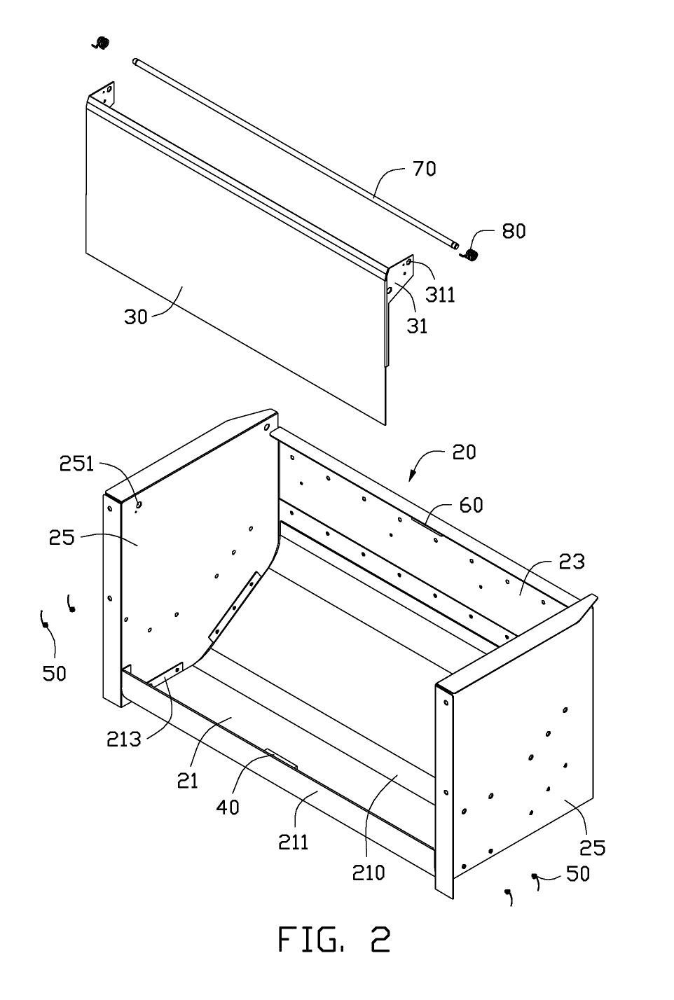

FIGS. 1 and 2 illustrate a vending machine in accordance with an embodiment. The vending machine includes a front plate 10, a delivery tray (cabinet 20) attached to the front plate 10, and a shielding plate 30 rotatably attached to the cabinet 20. The front plate 10 defines an opening 11 for fetching merchandises from the cabinet 20.

The cabinet 20 includes a receiving portion 21, a first side panel 23, and two parallel second side panels 25. An entrance 27, for the merchandise to drop into the cabinet 20, is defined in the cabinet 20. In one embodiment, the receiving portion 21 is arcuate, and a concave slot 210 is defined in the receiving portion 21, for receiving the merchandise. A securing flange 211 extends from a first edge of the receiving portion 21, and two mounting flanges 213 extend from opposite second edges of the receiving portion 21. In one embodiment, the securing flange 211 is substantially parallel to the first side panel 23 and perpendicular to the two mounting flanges 213.

A first electromagnet 40 is secured to an inner surface of the securing flange 211. Each of the two mounting flanges 213 is attached to each of the two second side panels 25, and two sensors 50 are secured to each of the two mounting flanges 213. A second electromagnet 60 is secured to a top portion of the first side panel 23. The sensors 50 detect whether the merchandise is received in the cabinet 20 and if so transmit a signal to the first and the second electromagnets 40, 60. For example, when the sensors 50 detects that the merchandise is received in the cabinet 20, a signal is sent to the first and the second electromagnets 40, 60 to power off the first electromagnet 40, and the second electromagnet 60 is energized to attract the shielding plate 30. Until the sensors 50 detect that the merchandise is in the cabinet 20, the second electromagnet 60 is powered off, and the first electromagnet 40 is energized to attract the shielding plate 30. A securing hole 251 is defined in each of the two second side panels 25.

Two retaining pieces 31 extend from opposite edge of the shielding plate 30. Each of the two retaining pieces 31 defines a retaining hole 311. The retaining holes 311 and the securing holes 251 are together used to secure a rotating post 70. Thus, the shielding plate 30 can be rotatably secured to the two second side panels 25 by the rotating post 70. In one embodiment, the shielding plate 30 is an iron plate.

FIGS. 1 and 2 illustrate assembly of the vending machine in accordance with an embodiment. In assembly, the rotating post 70 passes through two of the retaining holes 311. At this point, the opposite ends of the rotating post 70 are located on the outside of each of the two retaining pieces 31. Two resilient members 80 are engaged with the opposite end of the rotating post 70 and abut the two retaining pieces 31. The opposite ends of the rotating post 70 are engaged in two of the securing holes 251, to rotatably secure the shielding plate 30 to the cabinet 20. At this point, each of the two resilient members 80 is located between each of the two retaining pieces 31 and each of the two second side panels 25. The cabinet 20 is secured to the front plate 10 by fasteners such as screws or hooks.

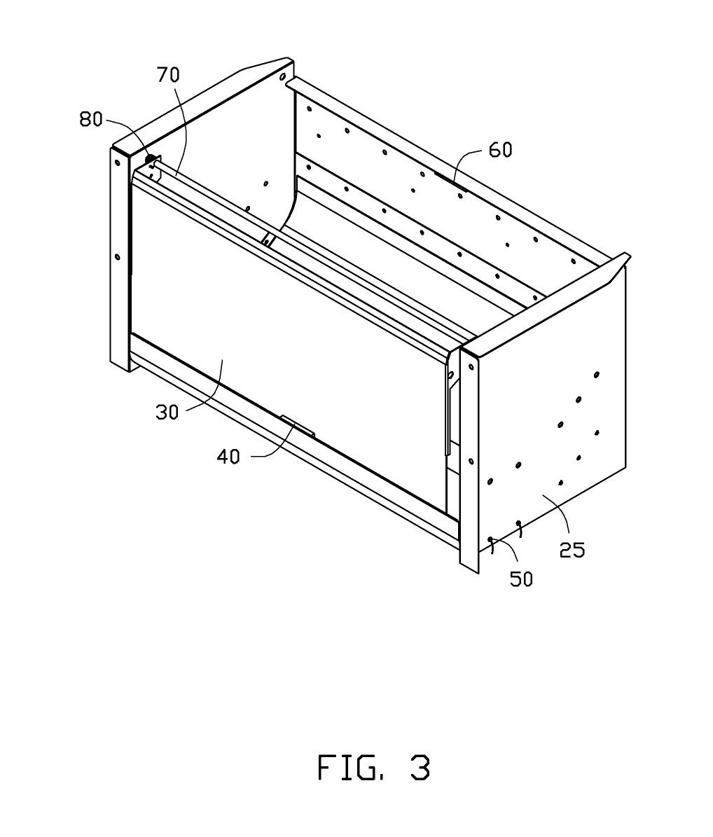

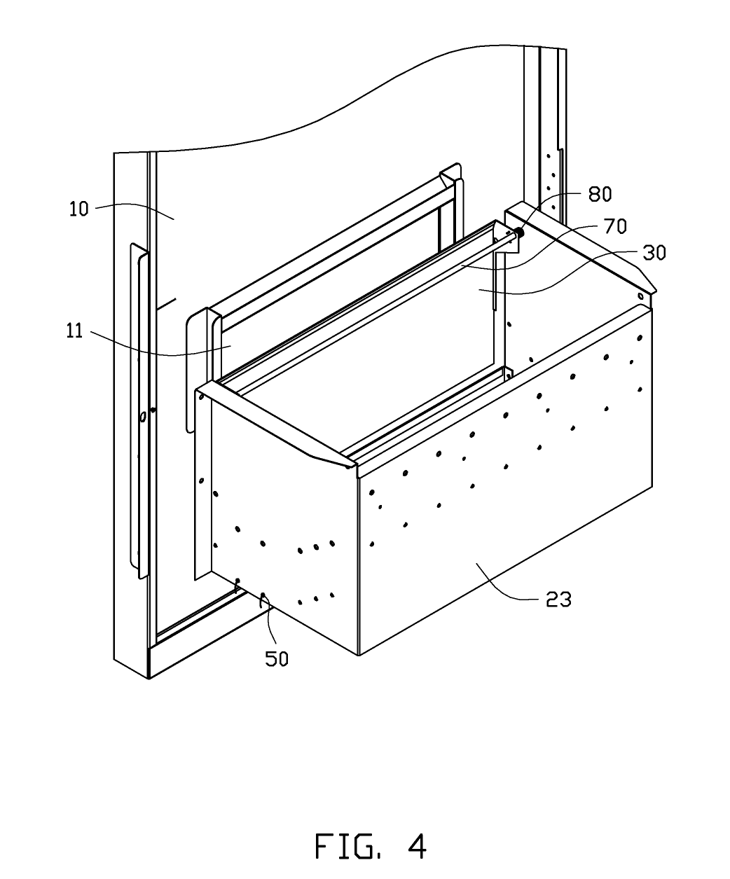

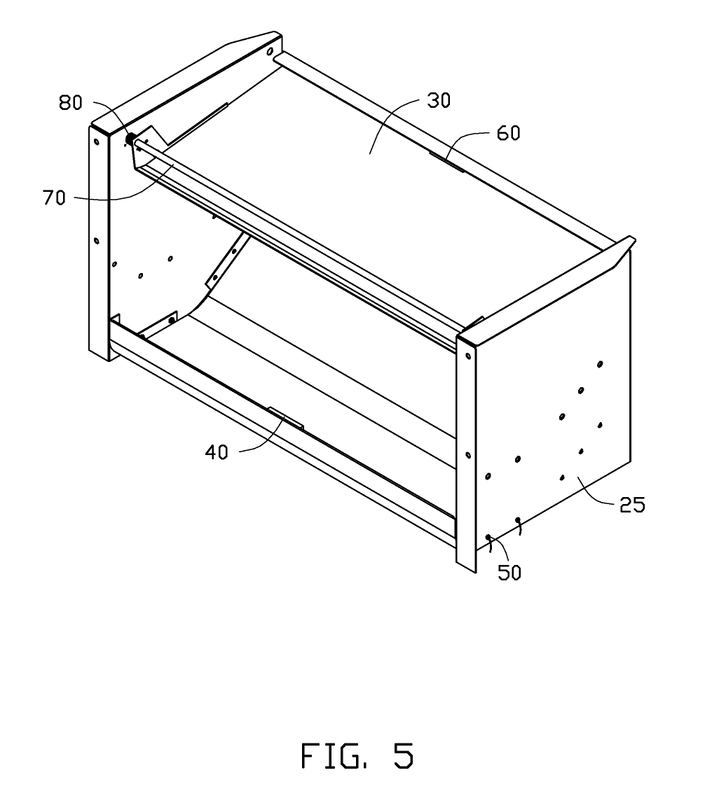

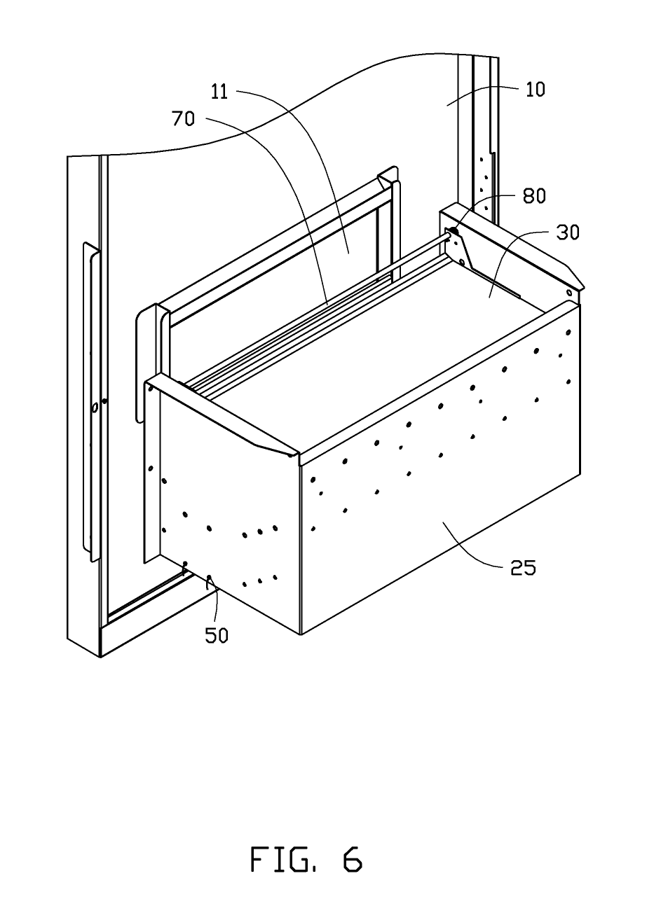

FIGS. 3-6 illustrate a view of the vending machine in use in accordance with an embodiment. The shielding plate 30 is rotatable relative to the cabinet 20 so as to be in a hanging or lower position (shown in FIGS. 3-4) and in a lifted or higher position (shown in FIGS. 5-6). In the lower position, the shielding plate 30 is engaged with the first electromagnet 40 and substantially parallel to the first side panel 23. In the higher position, the shielding plate 30 is engaged with the second electromagnet 60 and is substantially perpendicular to the first side panel 23, to cover the entrance 27, and the two resilient members 80 are thereby deformed. In one embodiment, when the merchandise is received in the concave slot 210, the shielding plate 21 cannot touch the merchandise when rotated from the lower position to the higher position.

In use, when the merchandise drops into the cabinet 20, the sensors 50 detect the merchandise in the cabinet 20, the first electromagnet 40 is switched of, and the second electromagnet 60 is switched on. The shielding plate 30 is rotated from the lower position to the higher position, to make contact with the second electromagnet 60. Simultaneously, the two resilient members 80 are deformed. Thus, the entrance 27 is covered by the shielding plate 30, and the customers have no access to the merchandise or additional merchandise through the entrance 27. When the merchandise is lifted out of the cabinet 20 from the opening 11 by customers, the sensors 50 detect the removal of the merchandise from the cabinet 20, and the second electromagnet 60 is switched of, and the first electromagnet 40 is switched on. The shielding plate 30 rotates from the higher position to the lower position, to again make contact with the first electromagnet 40. Simultaneously, the two resilient members 80 are released from compression. Thus, the opening 11 is again covered and closed by the shielding plate 30, to prevent buyer access through the opening 11.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
a front plate defining an opening;
a cabinet attached to the front plate and defining an entrance; the cabinet comprises a first electromagnet, a second electromagnet, and a sensor on the cabinet; the sensor is connected to the first electromagnet and the second electromagnet;
a shielding plate rotatably attached to the cabinet;
wherein the sensor is adapted to detect whether a merchandise drops into the cabinet and transfer a signal to the first electromagnet and the second electromagnet; when the sensor detects no merchandise is received in the cabinet, the shielding plate is engaged with the first electromagnet to cover the opening; when the sensor detects the merchandise is received in the cabinet, the shielding plate is engaged with the second electromagnet to cover the entrance.

2. The vending machine of claim 1, wherein the cabinet comprises a first side panel and a securing flange attached to the front plate, the first electromagnet is attached to the securing flange, and the second electromagnet is attached to the first side panel.

3. The vending machine of claim 2, wherein the securing flange is substantially parallel to the first side panel.

4. The vending machine of claim 2, wherein the cabinet further comprises a receiving portion connected to the first side panel, and a concave slot is located on the receiving portion for receiving the merchandise.

5. The vending machine of claim 4, wherein the receiving portion is arcuate.

6. The vending machine of claim 1, further comprising a rotating post, and the shielding plate is rotatably secured to the cabinet by the rotating post.

7. The vending machine of claim 6, further comprising a resilient member surrounding the rotating post, the resilient member being deformable and located between the shielding plate and the cabinet.

8. The vending machine of claim 7, further comprising a retaining piece substantially perpendicularly extending from the shielding plate, the cabinet further comprises a second side panel connected to the first side panel, and the resilient member is sandwiched between the second side panel and the retaining piece.

9. The vending machine of claim 8, further comprising a mounting flange extending from the receiving portion and attached to the second side panel, and the sensor being secured to the second side panel.

10. A vending machine comprising:
a front plate defining an opening;
a cabinet attached to the front plate and comprising a first side panel, an entrance defined in the cabinet; the cabinet comprises a first electromagnet, a second electromagnet, and a sensor on the cabinet; the sensor is connected to the first electromagnet and the second electromagnet;
a shielding plate rotatably attached to the cabinet; the shielding plate is rotatable relative to the cabinet between a lower position and a higher position, when the shielding plate is in the lower position, the shielding plate is substantially parallel to the first side panel to cover the opening, and when the shielding plate is in the higher position, the shielding plate is substantially perpendicular to the first side panel to cover the entrance;
wherein the sensor is adapted to detect whether a merchandise drops into the cabinet and transfer a signal to the first electromagnet and the second electromagnet; when the sensor detects no the merchandise is received in the cabinet, the shielding plate is in the lower position and engaged with the first electromagnet; when the sensor detects the merchandise is received in the cabinet, the shielding plate is rotated to the higher position and engaged with the second electromagnet.

11. The vending machine of claim 10, wherein the cabinet comprises a securing flange attached to the front plate, the first electromagnet is attached to the securing flange, and the second electromagnet is attached to the first side panel.

12. The vending machine of claim 11, wherein the securing flange is substantially parallel to the first side panel.

13. The vending machine of claim 10, wherein the cabinet further comprises a receiving portion connected to the first side panel, and a concave slot is located on the receiving portion for receiving the merchandise.

14. The vending machine of claim 13, wherein the receiving portion is arcuate.

15. The vending machine of claim 10, further comprising a rotating post, and the shielding plate is rotatably secured to the cabinet by the rotating post.

16. The vending machine of claim 15, further comprising a resilient member surrounding the rotating post, wherein the resilient member is deformable and located between the shielding plate and the cabinet.

17. The vending machine of claim 16, further comprising a retaining piece substantially perpendicularly extending from the shielding plate, the cabinet further comprises a second side panel connected to the first side panel, and the resilient member is sandwiched between the second side panel and the retaining piece.

18. The vending machine of claim 17, further comprising a mounting flange extending from the receiving portion and attached to the second side panel, and the sensor is secured to the second side panel.

19. A merchandise output method of a vending machine, comprising:
detecting a merchandise in a cabinet of the vending machine by a sensor;
unlocking a shielding plate of the vending machine at a lower position by powering off a first electromagnet of the cabinet, and locking the shielding plate at a higher position by powering on a second electromagnet of the cabinet ;
detecting no merchandise in the cabinet; and
powering on the first electromagnet to lock the shielding plate at the lower position and powering off the second electromagnet to unlock the shielding plate at the higher position.
